(19) United States
(12) Patent Application Publication
(10) Pub. No.: US 2024/0367273 A1
(43) Pub. Date: Nov. 7, 2024

(54) PRESSING APPARATUS FOR ELECTRONIC CIGARETTE CARTRIDGE DECORATIVE RING

(71) Applicant: SHENZHEN HANQINGDA TECHNOLOGY CO., LTD., Shenzhen, Guangdong (CN)

(72) Inventors: Shoushan HOU, Shenzhen, Guangdong (CN); Hua DENG, Shenzhen, Guangdong (CN); Jiangtao LI, Shenzhen, Guangdong (CN)

(21) Appl. No.: 18/265,201

(22) PCT Filed: Dec. 21, 2022
(86) PCT No.: PCT/CN2022/140534

§ 371 Date: Jun. 2, 2023

(30) Foreign Application Priority Data
Mar. 21, 2022 (CN) 202220616315.9

(51) Int. Cl. B23P 19/027; A24F 40/42; A24F 40/70

(52) U.S. Cl. CPC B23P 19/027; A24F 40/42; A24F 40/70

(57) ABSTRACT

A pressing apparatus for an electronic cigarette cartridge decorative ring is disclosed, including a controller and a supporting seat. The supporting seat is provided with a clamping fixture, the clamping fixture is provided with cartridge placing holes, decorative ring placing grooves are provided in peripheries of upper ends of the cartridge placing holes, and a central axis of the cartridge placing holes coincides with that of the decorative ring placing grooves. The supporting seat is provided with a pressing mechanism, the pressing mechanism includes driving pieces and pressing heads, the driving pieces are connected to the supporting seat and connected with the controller, the pressing heads are connected to output ends of the driving pieces and limited at positions right above the cartridge placing holes, and the driving pieces can drive the pressing heads to lift up and down.

### TECHNICAL FIELD

The disclosure belongs to the field of production devices for electronic cigarettes, and particularly relates to a pressing apparatus for electronic cigarette cartridge decorative ring.

### BACKGROUND

Electronic cigarette is an electronic product used for replacing a traditional cigarette by heating E-liquid, tobaccos, cigarette paste, solid cartridge or other substances to form smoke. Among existing electronic cigarette products, an electronic cigarette product named electronic cigarette with convenience and rapidness in cigarette replacement is popular. Because the electronic cigarette cartridge needs to be cooperated with control on a power supply device when in use, and it is small in size like a bullet and capable of rapid replacement, so it is named “cartridge”. The electronic cigarette cartridge is a necessary accessory mounted on a portable electronic cigarette atomizer. The cartridge includes an E-liquid storage body and a mouthpiece. The cartridge stores a certain quantity of E-liquid therein. When the electronic cigarette works, the E-liquid in the cartridge is atomized into gas under the effect of the atomizer, and then smoke like real smoke is provided.

As shown in FIG. 1, during production of the cartridge, in order to make an appearance of the cartridge more beautiful, a decorative ring may be designed and nested on an outer side of the cartridge generally. In the prior art, during processing of the cartridge, due to a lack of a proper apparatus and device, all current decorative rings are manually pressed on the cartridges by a worker, which wastes time and labor, makes the assembly quality uneven, and then severely affects the processing efficiency.

### SUMMARY

In order to solve the technical problems existing in the prior art, the disclosure provides a pressing apparatus for an electronic cigarette cartridge decorative ring and specifically provides the following technical solution.

A pressing apparatus for an electronic cigarette cartridge decorative ring includes a controller and a supporting seat. The supporting seat is provided with a clamping fixture, the clamping fixture is provided with cartridge placing holes, decorative ring placing grooves are respectively provided in peripheries of upper ends of the cartridge placing holes, and a central axis of each of the cartridge placing holes coincides with a central axis of a respective one of the decorative ring placing grooves. The supporting seat is provided with a pressing mechanism, the pressing mechanism comprises driving pieces and pressing heads, the driving pieces are connected with the supporting seat and connected with the controller, the pressing heads are respectively connected with output ends of the driving pieces and limited at positions right above the cartridge placing holes, and the driving pieces are capable of driving the respective pressing heads to lift up and down.

As a further improvement of the disclosure, the driving pieces are pressing cylinders, the pressing cylinders are connected with the controller, and fixedly mounted on the supporting seat, and moving ends of the pressing cylinders are fixedly connected with the pressing heads respectively.

As a further improvement of the disclosure, ten cartridge placing holes are equidistantly distributed on the clamping fixture in a line, the decorative ring placing grooves are provided in the peripheries of the respective cartridge placing holes, the pressing heads are arranged identically in number to the cartridge placing holes, and are in one-to-one correspondence to the cartridge placing holes.

As a further improvement of the disclosure, a product pick-and-place port is provided in a front end of the supporting seat, and safety gratings are arranged on two sides of the product pick-and-place port respectively, and connected with the controller.

As a further improvement of the disclosure, the pressing heads are made of casting polyurethane.

As a further improvement of the disclosure, the supporting seat is provided with a start button and a stop button, and the start button and the stop button are connected with the controller respectively.

As a further improvement of the disclosure, the supporting seat is provided with an emergency stop button, and the emergency stop button is connected with the controller.

As a further improvement of the disclosure, the supporting seat is provided with a reset button, and the reset button is connected with the controller.

As a further improvement of the disclosure, four cushion pads are arranged on a lower surface of the supporting seat, and rectangularly distributed on the lower surface of the supporting seat.

As a further improvement of the disclosure, the cushion pads are made of rubber materials.

The disclosure has the beneficial effects as follows.

In the disclosure, by arranging the clamping fixture on the supporting seat and providing the cartridge placing holes and the decorative ring placing grooves in the clamping fixture, if there is a need for pressing decorative rings on the cartridges, the decorative rings are placed in the decorative ring placing grooves. Then the cartridges are placed in the cartridge placing holes: the cartridges and the decorative rings can be pre-mounted and limited through limitation of the cartridge placing holes and the decorative ring placing grooves: then, the controller controls the driving pieces to work, and then the driving pieces drive the pressing heads to press downward. Since the pressing heads are located right above the cartridge placing holes, the pressing heads may tightly press the cartridges during descending, and then press down the cartridges, and thus the cartridges are pressed into the decorative rings to finish pressing of the decorative rings. The disclosure can rapidly press the cartridge decorative rings, solve the problem of poor quality of a product due to manual mounting of the decorative rings, further weaken the labor intensity of an operator and increase the processing efficiency and a yield.

### BRIEF DESCRIPTION OF DRAWINGS

In order to more clearly illustrate the technical solutions of the embodiments of the disclosure or the prior art, the drawings that are required to describe the embodiments or the prior art will be briefly introduced below. Apparently, the drawings that are described below are some embodiments of the disclosure, and a person of ordinary skill in the art can obtain other drawings according to these drawings without creative work.

FIG. 1 is a structural schematic diagram of a cartridge after pressing of a decorative ring in the disclosure;

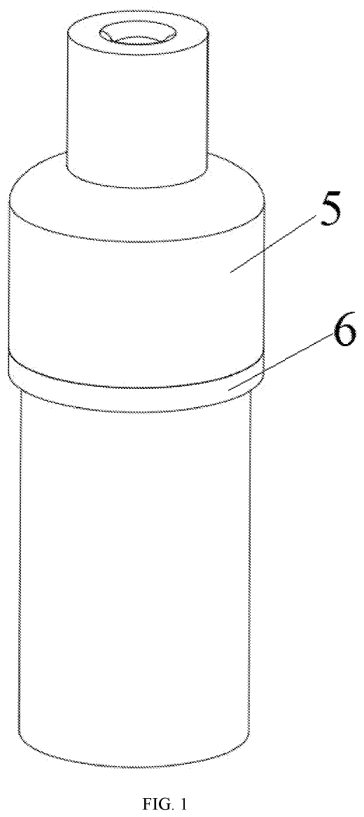

FIG. 2 is a schematic diagram of an overall structure according to an embodiment of the disclosure;

FIG. 3 is an enlarged view of a part A in FIG. 2; and

FIG. 4 is a structural schematic diagram of a pressing mechanism according to an embodiment of the disclosure.

### DETAILED DESCRIPTION

Unless otherwise defined, all the technical and scientific terms used herein have the same meanings as those commonly understood by a person of ordinary skill in the art. Terms used herein in the specification of the disclosure are for the purpose of describing specific embodiments only and are not intended to limit the disclosure. Furthermore, that terms “comprise” and “have” and any variations thereof in the specification and claims as well as the above drawings of the disclosure are intended to cover non-exclusive inclusion. The terms “first”, “second” and the like in the specification and claims as well as the above drawings of the disclosure are used to distinguish between different objects, and are not necessarily used to describe a specific sequence.

Reference in the specification to “an embodiment” means that a particular feature, structure, or characteristic described in connection with the embodiment may be included in at least one embodiment of the disclosure. The appearances of the phrase in various places in the specification are not necessarily all referring to the same embodiment, nor are separate or alternative embodiments mutually exclusive of other embodiments. It is to be expressly and implicitly understood by a person of ordinary skill in the art that the embodiments described herein may be combined with other embodiments without conflict.

In order to make a person of ordinary skill in the art better understand the solutions of the disclosure, the technical solutions in the embodiments of the disclosure will be described clearly and completely with the attached drawings.

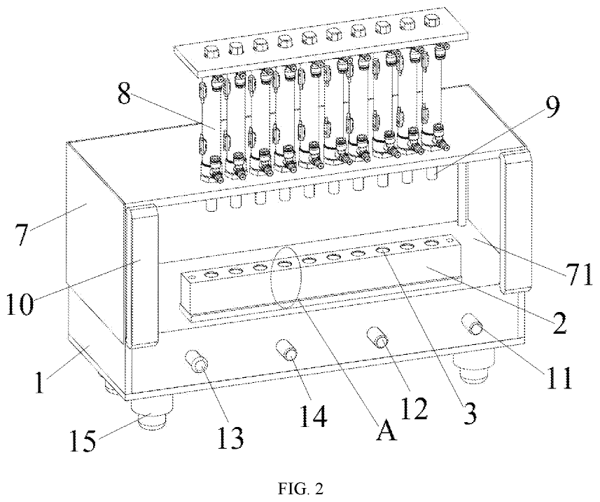

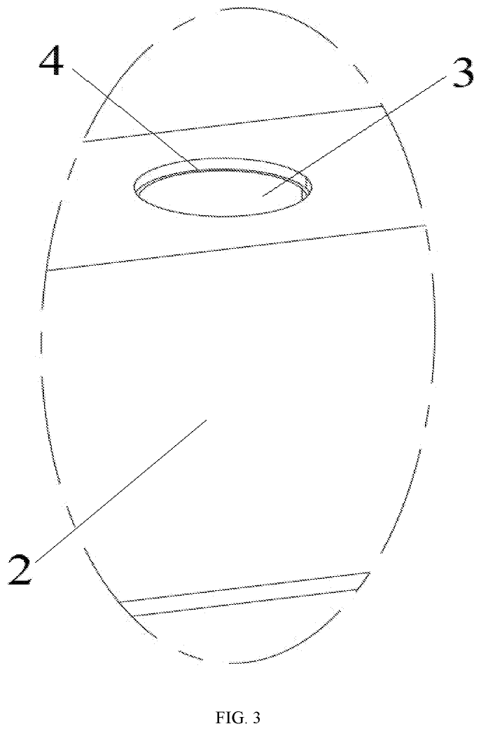

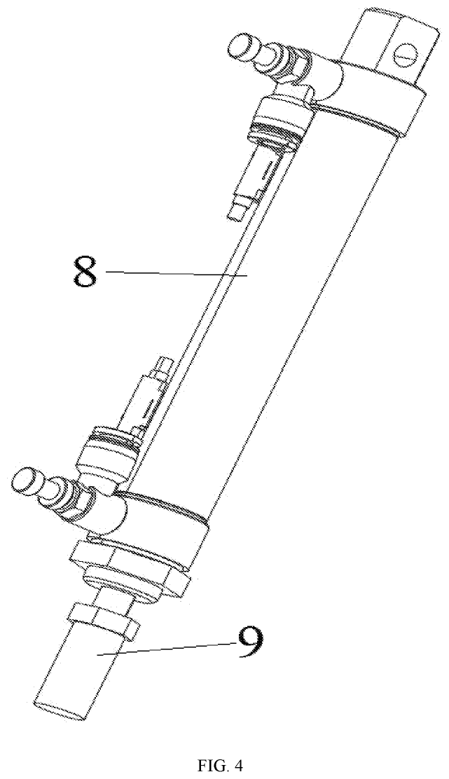

As shown in FIGS. 2-4, a pressing apparatus for an electronic cigarette cartridge decorative ring includes a controller and a supporting seat 1. The supporting seat 1 is a body supporting structure for the pressing apparatus for an electronic cigarette cartridge decorative ring, and may be made of a rigid metal material or a plastic material. The supporting seat 1 is fixedly provided with a clamping fixture 2, the clamping fixture 2 is provided with cartridge placing holes 3. A decorative ring placing groove 4 is provided in a periphery of an upper end of each cartridge placing hole 3, and a central axis of the cartridge placing hole 3 coincides with that of the decorative ring placing groove 4. Each cartridge placing hole 3 has a size adapted to an outer surface of a cartridge 5, and the decorative ring placing groove 4 has a size adapted to a decorative ring 6. A bracket 7 is fixedly mounted on the supporting seat 1 and is provided with a pressing mechanism. The pressing mechanism includes driving pieces 8 and pressing heads 9, the driving pieces 8 are fixedly mounted on the bracket 7 and connected with the controller. The pressing heads 9 are fixedly connected with output ends of the driving pieces 8, the number of the pressing heads 9 is the same as that of the cartridge placing holes 3. The pressing heads 9 are limited at positions right above the cartridge placing holes 3, and the driving pieces 8 can drive the pressing heads 9 to lift up and down.

When in operation, a user places the decorative rings 6 in the decorative ring placing grooves 4, and then places the cartridges 5 in the cartridge placing holes 3, and the cartridges 5 and the decorative rings 6 can be pre-mounted and limited through limitation of the cartridge placing holes 3 and the decorative ring placing grooves 4. Then, the controller controls the driving pieces 8 to work, and then the driving pieces 8 drive the pressing heads 9 to press downward. Since the pressing heads 9) are located right above the cartridge placing holes 3, the pressing heads 9 may tightly press the cartridges 5 during descending, and then press down the cartridges 5, and thus the cartridges 5 are pressed into the decorative rings 6 to finish pressing of the decorative rings 6.

In an embodiment, the driving pieces 8 are pressing cylinders connected with the controller and fixedly mounted on the bracket 7. Moving ends of the pressing cylinders are fixedly connected with the pressing heads 9. In other embodiments, the driving pieces 8 may also be of other mechanical structures, for example, gear motors and the like.

In order to ensure the precision of pressing, and avoid the pressing heads 9 from damaging the appearances of the cartridges 5 during pressing, in an embodiment, the pressing heads 9 are made of casting polyurethane which is also called a polyurethane (PU) elastomer. The casting polyurethane is good in strength and small in compressive deformation, and is a novel material between plastics and the rubber, having both the rigidity of the plastics and the elasticity of the rubber. In other embodiments, the pressing heads 9 may also be made of other materials having the rigidity and the elasticity.

In order to improve the pressing efficiency, in an embodiment, ten cartridge placing holes 3 are equidistantly distributed on the clamping fixture 2 in a line. The decorative ring placing groove 4 is provided in the periphery of each cartridge placing hole 3. The number of the driving pieces 8 and the number of the pressing heads 9 are both the same as that of the cartridge placing holes 3, and the pressing heads 9 are in one-to-one correspondence to the cartridge placing holes 3. Through the above structure, the user may fill ten cartridges 5 and ten decorative rings 6 at one time, thereby improving the processing efficiency. In other embodiments, the clamping fixture 2 may also be provided with any other numbers of cartridge placing holes 3.

A product pick-and-place port 71 is provided in a front end of the bracket 7. The product pick-and-place port 71 is arranged for facilitating the user to fill the cartridges 5 and the decorative rings 6 on the clamping fixture 2. Safety gratings 10 are arranged on two sides of the product pick-and-place port 71 respectively, and connected with the controller. The safety gratings 10 are arranged for preventing the operator from putting his/her hands or other portions of his/her body into the bracket 7 by mistake during work of the pressing apparatus for an electronic cigarette cartridge decorative ring. If the operator puts his/her hands or other portions of his/her body into the bracket 7, an association between the safety gratings 10 on the two sides may be cut off, then the safety gratings 10 may send signals to the controller, and the controller automatically controls the pressing apparatus for an electronic cigarette cartridge decorative ring to stop working, thereby protecting personal safety of the operator.

A start button 11, a stop button 12, an emergency stop button 13 and a reset button 14 are mounted on a side wall of the supporting seat 1 close to the product pick-and-place port 71, and are connected with the controller respectively. The start button 11 is configured to control the pressing apparatus for an electronic cigarette cartridge decorative ring to be powered on and start to work, the stop button 12 is configured to control the pressing apparatus for an electronic cigarette cartridge decorative ring to stop working, the emergency stop button 13 is configured to control the driving pieces to stop moving in an emergency case, and the reset button 14 is configured to control the driving pieces to rapidly rest.

Four cushion pads 15 made of rubber materials are arranged on a lower surface of the supporting seat 1, and rectangularly distributed on the lower surface of the supporting seat 1. Through arrangement of the cushion pads 15, on one hand, vibration generated by operation of the pressing apparatus for an electronic cigarette cartridge decorative ring can be reduced, thereby prolonging the service life of the apparatus, and on the other hand, the cushion pads 15 can also serve to support the pressing apparatus for an electronic cigarette cartridge decorative ring, thereby facilitating the operator to mount the cartridges 2 and the decorative rings 6.

### Working Principle

The pressing apparatus for an electronic cigarette cartridge decorative ring is placed on a proper workbench first, and the apparatus can be supported by the cushion pads 15, so as to be fixed on the workbench.

When the pressing apparatus for an electronic cigarette cartridge decorative ring works, the operator places the ten decorative rings 6 in the corresponding decorative ring placing grooves 4 first, and then places the ten cartridges 5 in the corresponding cartridge placing holes 3, so as to pre-mount the cartridges 5 and the decorative rings 6. Then, the operator makes the pressing apparatus for an electronic cigarette cartridge decorative ring be powered on and work by operating the start button 11, and the controller controls the driving pieces 8 to start to work, the driving pieces 8 drive the pressing heads 9 to press downward, and the pressing heads 9 press the cartridges 5 downward, so that the cartridges 5 are pressed into the decorative rings 6 to finish pressing of the decorative rings 6.

After pressing, the user makes the pressing apparatus for an electronic cigarette cartridge decorative ring be powered off and stop working by operating the stop button 12, and then takes the cartridges with the decorative rings pressed properly out of the clamping fixture 2. The above operations are repeated until all the cartridge decorative rings are pressed finally. If there are some emergency cases during pressing, for example, the decorative rings 6 or the cartridges 5 are not mounted well, the user may make the driving pieces 8 stop moving by operating the emergency stop button 13, make the driving pieces 8 reset by operating the reset button 14, and then finish pressing of the decorative rings by operating the start button 11 after it gets back to normal.

Apparently, the described embodiments above are only a few, but not all embodiments of the disclosure. The preferred embodiments of the disclosure are provided in the drawings, and are not intended to limit the scope of the disclosure. The disclosure may be implemented in many different forms. These embodiments are provided so as to provide more thorough and comprehensive understanding of the disclosure. Although the disclosure has been described in detail with respect to the previously described embodiments, to a person of ordinary skill in the art, the technical solutions recorded in various particular implementations may be still modified, or part of its technical features may be replaced with equivalents. Any equivalent structure which is made by using the contents of the description and drawings of the disclosure and directly or indirectly applied in other related technical fields, equally falls within the scope of the disclosure.

1. A pressing apparatus for an electronic cigarette cartridge decorative ring, comprising a controller and a supporting seat, wherein the supporting seat is provided with a clamping fixture, the clamping fixture is provided with cartridge placing holes, decorative ring placing grooves are respectively provided in peripheries of upper ends of the cartridge placing holes, and a central axis of each of the cartridge placing holes coincides with a central axis of a respective one of the decorative ring placing grooves; and
the supporting seat is provided with a pressing mechanism, the pressing mechanism comprises driving pieces and pressing heads, the driving pieces are connected with the supporting seat and connected with the controller, the pressing heads are respectively connected with output ends of the driving pieces and limited at positions right above the cartridge placing holes, and the driving pieces are capable of driving the respective pressing heads to lift up and down.

2. The pressing apparatus for an electronic cigarette cartridge decorative ring according to claim 1, wherein the driving pieces are pressing cylinders, the pressing cylinders are connected with the controller, and fixedly mounted on the supporting seat, and moving ends of the pressing cylinders are fixedly connected with the pressing heads respectively.

3. The pressing apparatus for an electronic cigarette cartridge decorative ring according to claim 2, wherein ten cartridge placing holes are equidistantly distributed on the clamping fixture in a line, the decorative ring placing grooves are provided in the peripheries of the respective cartridge placing holes, the pressing heads are arranged identically in number to the cartridge placing holes, and are in one-to-one correspondence to the cartridge placing holes.

4. The pressing apparatus for an electronic cigarette cartridge decorative ring according to claim 1, wherein a product pick-and-place port is provided in a front end of the supporting seat, and safety gratings are arranged on two sides of the product pick-and-place port respectively, and connected with the controller.

5. The pressing apparatus for an electronic cigarette cartridge decorative ring according to claim 1, wherein the pressing heads are made of casting polyurethane.

6. The pressing apparatus for an electronic cigarette cartridge decorative ring according to claim 1, wherein the supporting seat is provided with a start button and a stop button, and the start button and the stop button are connected with the controller respectively.

7. The pressing apparatus for an electronic cigarette cartridge decorative ring according to claim 1, wherein the supporting seat is provided with an emergency stop button, and the emergency stop button is connected with the controller.

8. The pressing apparatus for an electronic cigarette cartridge decorative ring according to claim 1, wherein the supporting seat is provided with a reset button, and the reset button is connected with the controller.

9. The pressing apparatus for an electronic cigarette cartridge decorative ring according to claim 1, wherein four cushion pads are arranged on a lower surface of the supporting seat, and rectangularly distributed on the lower surface of the supporting seat.

10. The pressing apparatus for an electronic cigarette cartridge decorative ring according to claim 9, wherein the cushion pads are made of rubber materials.
